(19) United States
(12) Patent Application Publication
(10) Pub. No.: US 2008/0304449 A1
(43) Pub. Date: Dec. 11, 2008

(54) Fa Assignment Method, Fa Assignment Module and Policy Server in the Wireless Portable Internet System

(76) Inventor: Ki Young Sung, Seoul (KR)

Correspondence Address: BLANK ROME LLP, 600 NEW HAMPSHIRE AVENUE, N.W., WASHINGTON, DC, 20037, US

(21) Appl. No.: 12/159,463

(22) PCT Filed: Dec. 28, 2006
(86) PCT No.: PCT/KR06/05805

§ 371 Date: Jun. 27, 2008

(30) Foreign Application Priority Data
Dec. 30, 2005 (KR) 10-2005-0135493

(51) Int. Cl. H04Q 7/20

(52) U.S. Cl. 370/329

(57) ABSTRACT

Provided are a broadband wireless access communication system, and a method for assigning a frequency assignment (FA) to a newly accessing portable subscriber station (PSS) when a radio access station in a portable Internet system serves a number of FAs. The method for assigning a FA includes the steps of: receiving a connection request signal from a PSS through a primary FA; acquiring a MAC address of the PSS in a connection initialization process with the PSS; acquiring information on the number of available FAs in a sector receiving the connection request signal; determining a FA for the PSS based on the MAC address and the number of the FAs; transmitting the determined FA information to the PSS; and changing the FA of the PSS from the primary FA to the determined FA.

### TECHNICAL FIELD

The present invention relates to a broadband wireless access communication system, and more particularly, to a method for assigning a frequency assignment (FA) to a newly accessing portable subscriber station when a radio access station in a portable Internet system serves a number of FAs.

### BACKGROUND ART

The wireless portable Internet is a next-generation communication system that provides mobility to a local area data communication system that uses a stationary access point as in a conventional wireless local area network (LAN).

FIG. 1 is a schematic diagram illustrating a wireless portable Internet system. The wireless portable Internet system includes a portable subscriber station 200, a radio access station (RAS) 300 in wireless communication with the subscriber station, a Access Control Router (ACR) 400 connected to the RAS 300 via a gateway, and an Internet network.

A conventional wireless LAN system, which is specified on the IEEE 802.11 standard, provides a wireless data communication system, which allows wireless communication in a short distance from a stationary access point. However, this method only supports wireless local area data communication for the subscriber station (SS), and does not support the mobility of the SS.

Meanwhile, a wireless portable Internet system suggested by the IEEE 802.16 group guarantees mobility for seamless data communication service even when the SS 200 shown in FIG. 1 moves from a cell under the control of the RAS 300 to a cell under the control of another RAS.

Several wireless portable Internet standards are being suggested, and International standardization of the portable Internet based on current IEEE 802.16d and 802.16e is proceeding. An Institute of Electrical and Electronics Engineers (IEEE) 802.16d and 802.16e communication system that is a broadband wireless access (BWA) communication system comprises a base station (BS) for managing a number of frequency assignments (hereinafter “FAs”). The SS communicates with the BS through one of a number of FAs. At first, the terminal communicates for initialization through a primary FA while establishing a communication channel to the BS, and then communicates through a FA selected from a number of the FAs available on the BS.

As the number of the FA that each BS can use is increased, the capacity can be increased. An issue of insufficient QoS due to concentration of terminals to a specific FA can be solved by evenly distributing the terminals to each FAs. Efficient distribution of traffics to the FAs guarantees excellent communication quality while the FAs adversely increase equipment and maintenance costs of the BS. Therefore, in a wireless communication business such as portable Internet business or mobile communication business, it is common that a BS uses a primary FA (Single-FA) when a service system network is initially built and then devices would be added to upgrade the BS to operate multiple FAs(Multi-FA) as communication traffic increases in the allocated region.

For the BS operating multi FAs as described above, it will be obvious that terminals located in the region of the BS must be evenly distributed to the FAs for traffic distribution, thereby achieving excellent communication quality. However, in conventional techniques suggested by the standards, the traffic can be switched to other FA by handoff system when excessive traffic is concentrated on any one FA.

As stated above, when excessive traffic is concentrated on a certain FA, the handoff system may switch the FA for a specific call, which is disclosed in Korean Patent No. 10-2005-0089685.

However, the suggested method is merely the step of hand off a specific call to another FA of the same radio access station (RAS) when excessive traffic is concentrated on one FA. There is a need for a method for distributing traffics to a number of FAs on the initial state of portable Internet communication for a specific call.

### DISCLOSURE

### Technical Problem

The present invention is directed to a method for assigning a FA, in which a FA can be determined from the early stage of connection of a portable subscriber station so that traffics are efficiently distributed to a number of FAs.

Furthermore, the present invention is directed to a method for assigning a FA, in which traffics can be efficiently distributed to a number of FAs using a MAC address for Internet communication without assigning a separate terminal identification code.

### Technical Solution

The first aspect of the present invention provides a method for assigning a frequency assignment (FA) in a wireless network system, the method comprising the steps of: acquiring a MAC address of a portable subscriber station (PSS) using subscriber information, the subscriber information being provided when the connection request is made by the PSS; acquiring the number of available FAs in a sector where the PSS is located, using history management information of a radio access station (RAS) to which the connection request is requested by the PSS; and determining a FA for the PSS based on the acquired MAC address and the number of available FAs and transmitting the FA information to the PSS.

The second aspect of the present invention provides a method for assigning a frequency assignment (FA) in a wireless portable Internet service system including a policy server, the method comprising the steps of: acquiring an identification value of the PSS using subscriber information, the subscriber information being provided when the connection request is made by the PSS; receiving FA information using the identification value of the PSS, the FA information being predetermined based on a subscriber service type by the policy server; and transmitting the received FA information to the PSS.

The third aspect of the present invention provides a method for assigning a FA in a wireless network, the method comprising the steps of: receiving a connection request signal from a PSS through a primary FA; initiating a process of initializing a connection with the PSS through the primary FA; checking a traffic distribution state of a sector to which a connection request is made by the PSS; and determining a FA for the PSS based on the traffic distribution state of the sector and transmitting the determined FA information to the PSS.

A FA assignment module according to the first aspect of the present invention, which may be included in the radio access station or the access control router, comprises: a MAC address acquiring unit for acquiring a MAC address of a PSS by retrieving subscriber information received from the PSS when the PSS is initialized for a connection; a FA information acquiring unit for acquiring information on the number of available FAs of a sector to which a connection request is made; and a FA determining unit for determining a FA for the portable subscriber station based on the acquired MAC address and the number of available FAs.

The policy server according to the second aspect of the present invention comprises an access control router interface for accessing an access control router of a wireless portable communication service system to perform data communication; a subscriber service DB for storing subscriber authentication information and service quality information; a radio access station DB for storing a FA holding status of the RASs connected to the ACR; a subscriber authentication module for authenticating service subscribers; and a FA determining unit for determining a FA for a PSS that makes a connection request, among available FAs of a RAS sector that receives the connection request.

### ADVANTAGEOUS EFFECTS

According to the method for assigning a FA of the present invention, it is possible to efficiently distribute traffics to a number of FAs in the early stage of connection of the portable subscriber station.

It is also possible to efficiently distribute the traffics using a MAC address for Internet communication without assigning a separate terminal identification code.

It is also possible to collectively distribute traffics at a policy server that performs subscriber's authentication.

### DESCRIPTION OF DRAWINGS

FIG. 1 illustrates a configuration of a typical wireless portable Internet system;

FIG. 2 is a flowchart illustrating a connection initialization process between a portable subscriber station and a wireless network system of the present invention;

FIG. 3 is a flowchart illustrating a method for assigning a FA according to one embodiment of the present invention;

FIG. 4 is a flowchart illustrating a method for assigning a FA according to another embodiment of the present invention;

FIG. 5 is a flowchart illustrating a method for assigning a FA according to still another embodiment of the present invention;

FIG. 6 is a block diagram illustrating a method for assigning a FA according to one embodiment of the present invention; and

FIG. 7 is a block diagram illustrating a policy server according to another embodiment of the present invention.

### DESCRIPTION OF MAJOR SYMBOL IN THE ABOVE FIGS

200: Portable subscriber station
300: Radio access station
360: FA assignment module
362: MAC address acquiring unit
364: FA information acquiring unit
366: FA determining unit
370: History management information DB
400: Access control router
500: Policy server
510: Access control router interface
520: Subscriber service DB
540: Radio access station DB
560: FA determining unit
580: Subscriber authenticating unit

### MODE FOR INVENTION

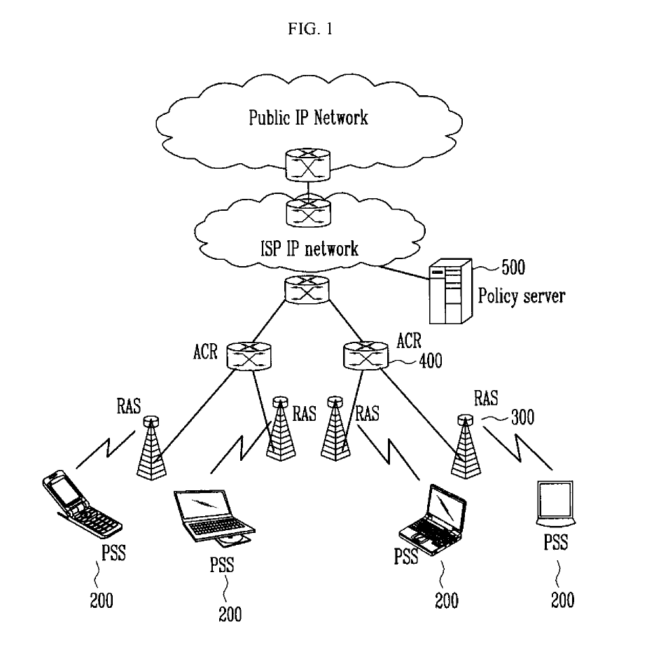

FIG. 1 illustrates the simplified configuration of a wireless portable Internet system to which the present invention may be applied. The portable Internet service system includes a portable subscriber station (PSS) 200 that a subscriber uses for Internet service; a radio access station (RAS) 300 for communicating with the portable subscriber station via a wireless interface; an access control router (ACR) 400 for controlling the RAS and routing IP packets; and a policy server 500, e.g., an Authentication, Authorization and Accounting (AAA) server, for performing authentication, authorization, and accounting on subscribers and terminals so that service is provided only to a rightful subscriber connecting to the portable Internet network.

First, terminologies used in describing embodiments of the present invention will be defined. Wireless network building equipment and a policy server for authentication of a wireless portable Internet service provider will be collectively referred to as a wireless Internet system, and radio access station (RAS) equipment and access control router (ACR) equipment for packet control in the wireless portable Internet will be collectively referred to as a wireless network system. The RAS equipment and the ACR equipment will be simply referred to as a RAS and an ACR, respectively.

Furthermore, a media access control (MAC) address indicates a unique number assigned to each of Ethernet network equipments. The portable subscriber station connecting to a wireless portable Internet also has a unique MAC address to indicate itself on network.

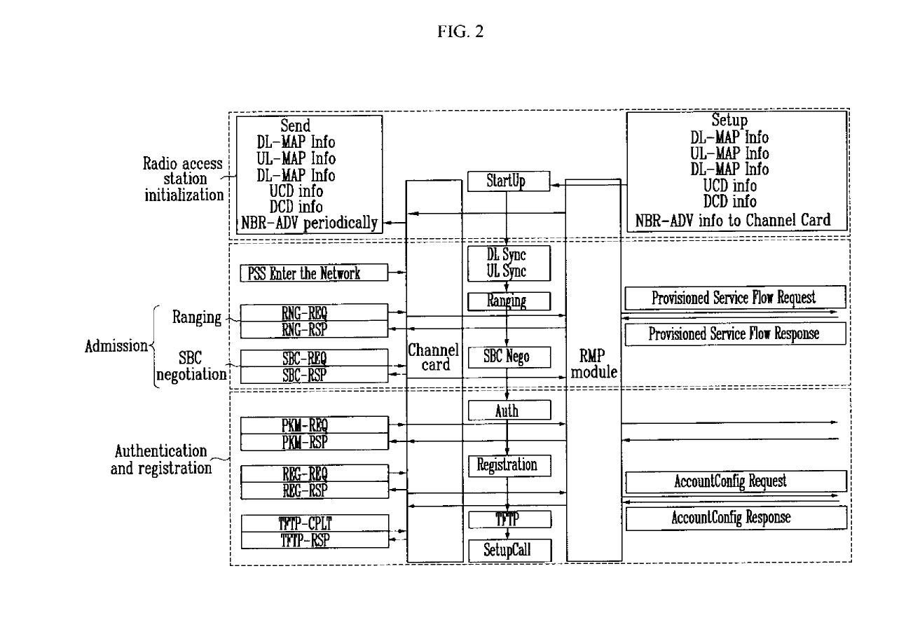

When the portable subscriber station is powered on, the initialization process performed in a wireless network system of a portable Internet system will be described. As shown in FIG. 2, when the portable subscriber station attempts to access a network, the wireless network system performs downlink synchronization (DL Sync) and uplink synchronization (UL Sync) with the PSS.

Then, the wireless network system receives an access request message (RNG-REQ) from the PSS and recognizes a MAC address of the PSS. In the case that ranging request is successful, the wireless network system transmits a ranging response message (RNG-RSP) to the PSS and then stores the MAC address in the authentication information space.

After the ranging process as above is completed, the wireless network system performs subscriber station basic capability negotiation (hereinafter, “SBC negotiation”) with the PSS, in which the PSS transmits a SBC negotiation request message (SBC-REQ) to the wireless network system for SBC negotiation and, in response to the request message, the wireless network system sends a response message (SBC-RSP) to the PSS. According to such SBC negotiation, a network entry procedure (admission process) for the PSS is completed. In the admission process, the wireless network system formulates and stores an admission context containing connection information for the PSS.

The admission context includes a user agent context based on the contents of the network-entry procedure. The user agent context (UAContext) DB stores the MAC address assigned to the PSS11(PSSMacAddress), a user ID, a call connection status, a connection identifier (BasicCID) for a message transmission sensitive to delay, a connection identifier (PrimaryCID) for a message transmission relatively less sensitive to delay, etc.

After the admission process is completed, a PKM authentication procedure is performed. The PSS transmits a subscriber authentication request message (PKM-REQ) to the wireless network system and, in response thereto, the wireless network system performs authentication using a policy server as an authentication server and transmits a subscriber authentication response message (PKM-REQ) to the PSS.

Next, the PSS transmits a registration request message (REG-REQ) to the RAS and, in response thereto, the wireless network system registers the PSS in the network and transmits a registration response message (REG-RSP) to the PSS.

In the case that the registration for the PSS is successful, the PSS transmits a Trivial File Transfer Protocol-CPLT (TFTP-CPLT) message for a file download path, and the wireless network system transmits a response message (TFTP-RSP) to the PSS, completing a call setup for the PSS.

Hereinafter, embodiments of the present invention will be described in detail with reference to the accompanying drawings so that those skilled in the art easily practice the present invention. However, the present invention may be implemented in several different forms and is not limited to the embodiments.

Although the operation of the network system related to the FA assignment and the subsequent processes will be described as being performed by the radio access station among wireless network systems in the following embodiments, most operations may be performed by the access control router, on which communications of radio access stations are concentrated, in case that the passive radio access stations are used.

While the following embodiments implements a wireless portable Internet system of the IEEE 802.16e standard, it is apparent that the present invention can be applied to the wireless portable Internet service system of the IEEE 802.16d standard.

### THE FIRST EMBODIMENT

The method for assigning a FA of the first embodiment is characterized in that it assigns a FA to be used by a PSS by hashing a MAC address of the PSS, which is transferred during a ranging process performed when the PSS is turned on and initialized.

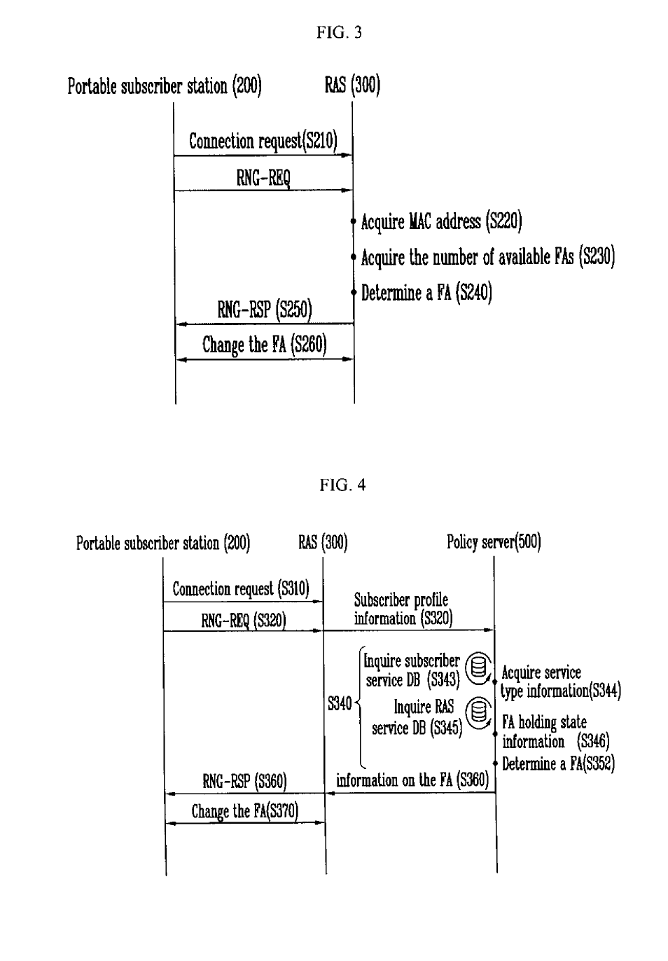

The method for determining a FA of the first embodiment in a RAS or an ACR of the wireless network system includes the steps of receiving a connection request signal through the primary FA from PSS 200 (S210); acquiring a MAC address of the PSS in an admission process with the PSS 200 (S220); acquiring information on the number of available FAs of a sector or a cell where the connection request signal is received (S230); determining a FA for the PSS 200 based on the MAC address and the number of the FAs (S240); and changing the FA of the PSS 200 from the primary FA to the determined FA (S260), as shown in FIG. 3. That is, the method for assigning a FA of the present embodiment includes acquiring the MAC address transmitted from the PSS 200 to the portable Internet service system in the admission process and assigning the FA using the MAC address.

The method for determining a FA may be performed by the RAS or the ACR for the wireless network system. The RAS or the ACR includes a FA assignment module for assigning the FA to the connected PSS as shown in FIG. 6. The FA assignment module 360 includes a MAC address acquiring unit 362 for acquiring a MAC address of the PSS that makes a request for connection; a FA information acquiring unit 364 for acquiring information on available FAs within a sector or a cell to which a connection request is received; and a FA determining unit 366 for determining the FA based on the acquired MAC address and the available-FA holding state.

The method for assigning a FA of FIG. 3 performed in the FA assignment module of FIG. 6 according to the present embodiment will now be described. It is assumed that a RAS provides three FASs, i.e., FA #1, FA #2, and FA #3. Here, the primary FA is FA #1.

Within the coverage of the RAS, the PSS 200 transmits a connection request to the wireless network system when the PSS is turned on (S210). In a ranging process responsive to the connection request, the PSS transmits a ranging request (“RNG_REQ”) message through the primary FA (FA #1), and receives a ranging response (“RNG_RSP”) message, responsive to the RNG_REQ message, through FA #1.

In the above process, the PSS transmits a MAC address, as the value to indicate itself, to the wireless network system, and the MAC address-acquiring unit 362 acquires the MAC address (S220). The FA information acquiring unit 364 acquires information on the number of available FAs within the sector or cell accessed by the PSS (S230). The information on the number of the available FAs can be easily retrieved from the history management information DB 370 in the RAS. The history management information DB 370 may be included in the RAS, the ACR, or the policy server. Preferably, the history management information DB 370 may be included in the radio access station for quick retrieval.

The FA determining unit 366 determines a FA for the PSS 200 based on the MAC address and the number of available FAs within the sector or the cell. The FA determining unit 366 may include a FA determination algorithm to determine the FA based on the MAC address and the number of available FAs in the RAS. The simplest example of the FA determination algorithm may be expressed by Equation 1:

Serial number of FA=MAC address % number of available FAs of the connected RAS. Equation 1

An operation “A % B” indicates “a remainder of division of A by B,” and the FA number equal to the remainder of the equation begins with 0, in which number 0 indicates a primary FA, and numbers 1, 2, . . . indicate additional FAs. When the number of the FAs in the RAS is two, a PSS having an even MAC address establishes a wireless communication channel through the primary FA indicated by number 0, and a PSS having an odd MAC address establishes a wireless communication channel through a first additional FA indicated by number 1.

For convenience of understanding, Equation 1 only shows the simplest algorithm. In order to prevent communication traffics from being concentrated on some FAs, it is desirable to use the algorithm that considers a range of MAC addresses assigned to a LAN card manufacturer, a range of MAC addresses that are more likely to be used geographically, a range of MAC addresses that can be assigned depending on a wireless communication service type and/or service providers, and the like.

When the FA determining unit 366 determines the FA, the wireless network system transmits information on the determined FA to the PSS 200 (S250). The FA information may be transmitted by a downlink burst profile in the RNG-RSP process. In this case, an identifier of a channel card to serve the FA determined in the sector or the cell of the RAS accessed by the PSS 200 may be transmitted. When every channel card of the RAS has a separate admission context of a PSS, the admission context for the PSS formulated by the channel card serving the primary FA can be sent to the channel card serving the determined FA.

Upon receipt of the FA determination notice, the PSS 200 changes the FA to the determined FA (S370). To change the FA, the PSS 200 performs an admission process, an SBC negotiation process and an authentication process through a channel card serving the determined FA to complete initialization, and then receives an assigned IP address to execute a portable Internet application. In this case, the admission process can be more simply performed using information obtained by performing the FA determination process. For example, an admission context is formulated while the FA may be determined, and a changed channel card value of the admission context may be modified after the FA is determined.

### THE SECOND EMBODIMENT

In the method for assigning a FA of the present embodiment, a policy server determines a FA for a PSS based on subscriber information, which is transmitted from the PSS to the policy server in a ranging process performed when the PSS is turned on and initialized. The policy server comprises a subscriber service DB for storing the subscriber information and a RAS DB for storing a FA holding status and/or a FA status of each RAS.

The method for determining a FA of the present embodiment performed by the wireless communication system having a RAS, an ACR, and a policy server includes the steps of: receiving a connection request signal of the PSS 200 through the primary FA (S310); transmitting subscriber information from the PSS to the policy server via the wireless network system when a connection initialization of the PSS is performed (S320); determining, by the policy server 500, a FA for the PSS 200 based on the subscriber information and identification information of the RAS (S340); transmitting the determined FA information from the policy server to the RAS 300 (S360); and changing, by the RAS 300 receiving the determined FA information, FA of the PSS to the determined FA (S370), as shown in FIG. 4.

If the method for determining a FA is rearranged for the sequence of the steps that may be performed by the RAS, it includes the steps of: acquiring an identification value of the PSS using subscriber profile information provided when the connection request is made by the PSS (S320); receiving FA information which is predefined based on a subscriber service type from the policy server, using the identification value of the PSS (S360); and transmitting the received FA information to the PSS.

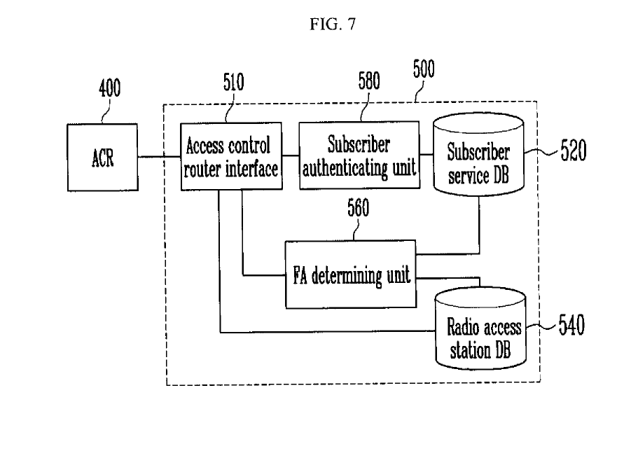

The policy server performing the method for determining a FA includes an ACR interface 510 connected to the ACR 400 of the wireless portable communication service system for performing data communication; a subscriber service DB 520 for storing a service type for a service subscriber and service quality information; a RAS DB 540 for storing information on a FA holding status of each RAS included in the wireless network system of the service provider; a subscriber authenticating unit 580 for authenticating the PSS attempting to access the wireless network system with reference to the subscriber service DB 520; and a FA determining unit 560 for acquiring the service type information of the subscriber by retrieving the subscriber service DB 520 using the subscriber information, retrieving the FA holding status of the RAS from the RAS DB 540 using the identification information of the RAS, and determining the FA based on the service type information and the FA holding status, as shown in FIG. 7.

The subscriber service DB 520 manages subscriber authentication information. Since a PSS of a subscriber should be checked when the subscriber is authenticated, the subscriber service DB 520 stores PSS information including a MAC address. The RAS DB 540 stores the operating state information of each RAS in the wireless network system managed by the policy server 500, and particularly, stores information on available-FA holding status of each sector or cell within each RAS.

Detailed processes of the method for assigning a FA according to the present embodiment will now be described with reference to FIGS. 4 and 7.

When the PSS 200 requests a connection (S310), the wireless network system and the PSS 200 perform the admission process, in which the subscriber information is sent to the policy server via the wireless network system (S320). The RNG-REQ signal transmitted from the PSS 200 to the RAS 300 includes subscriber information, which is sent on the RNG-REQ signal or other type of signal to the policy server 500. Meanwhile, the communication packet transmitted to the policy server, which includes the subscriber information, may include a source indication which sector or cell of which RAS has sent the packet.

The FA determining unit 560 inquires the subscriber service DB 520 using a terminal identifier or subscriber identifier (e.g., an MAC address, a user ID) contained in the subscriber information (S343) and checks a service type corresponding to a subscriber having the PSS (S344). The FA determining unit 560 also acquires quality information (e.g., QoS) of the service type and information of the service type. The service type and the quality thereof may be managed in a separate DB or may be stored in the subscriber service DB.

The FA determining unit 560 also inquires the source indication (i.e., identification values of the RAS and the sector) from the RAS DB 540 (S345) and acquires the information on an available-FA holding status of the sector that the PSS attempts to access (S346). The FA determining unit 560 then determines a FA for the PSS based on the service type information for the PSS 200, the quality information, and the information on available-FA holding status of the sector within the RAS 300 (S352). The following methods for determining a FA may be implemented depending on a service provider's policy.

A first method is a method applied when a FA assignment policy of the RAS does not consider the service quality. In this case, the FA may be assigned to the PSS using Equation 1 and a similar process based on the number of available FAs as the holding status information of the available FA. Here, the MAC address of the PSS may be used as in Equation 1, or another identifier such as a subscriber ID may be used.

A second method is a method applied when the FA assignment at the RAS sector differs depending on service quality. When the service quality assigned to the PSS is premium, the FA determining unit inquires RAS DB using the holding status information of available FAs in the RAS to check whether there is a premium private FA in the RAS. When there is the premium private FA, the FA determining unit determines it as the FA for the PSS. When normal service is assigned to the or when there is no premium private FA in the RAS, the FA is determined by the system according to the first method or the following third method.

A third method is a method applied when service quality differs depending on the type but the FA assignment at the RAS is not dependent on the quality. Since the use of more traffics is allowed for higher-quality of service, it must be considered in the traffic distribution to a number of FAs. In a simpler example, a weight is given to every service quality in order to calculate traffics. It is assumed that when there are two FAs, FA #1 and FA#2, in which FA #1 includes one normal service channel and four premium service channels and FA #2 includes five normal service channels and one premium service channel, connection of one new normal channel is requested. It can be seen that when a weight of 1.8 is given to the premium service, FA #1 has traffics of 8.2(=1+4*1.8), and FA #2 has traffics 6.8 (=5+1.8). Since the new normal channel must be assigned to the FA #2 so that traffic distribution is uniform, the FA determining unit will determine FA #2 as the FA for the PSS.

The information on the FA determined by the policy server is transmitted to the PSS via the ACR and the RAS (S360). The FA may be notified using the downlink burst profile in the RNG-RSP process.

Upon receipt of the FA determination notification, the PSS performs an admission process, an SBC negotiation process and an authentication process through a channel card serving the determined FA to complete the initialization. The PSS is then assigned an IP address to execute a portable Internet application (S370). In this case, the admission process may be more simply performed using the information obtained by performing the FA determination process. For example, an admission context may be formulated while the operating FA is determined, and then only a changed channel card value of the admission context may be modified.

In order to simply maintain a premium private FA when it exists, the premium FA is used for an initial network entry request by the PSS, and if service of the PSS is not a premium class as a result of communication with the policy server, the RAS transmits an RES-CMD to request reconnection of the PSS. In this case, in a ranging process responsive to an entry request re-attempted by the PSS, the FA of the PSS is changed to the FA determined by the policy server through a downlink burst profile.

### THE THIRD EMBODIMENT

The method for assigning a FA of the present embodiment is performed in a ranging process when the PSS is turned on and initialized. The method is performed by the RAS for quicker response and convenience of management, and the FA is determined using service quality information and traffic distribution state for more effective inter-FA traffic distribution.

The method for determining a FA in the RAS or the ACR of the wireless network system according to the present embodiment includes the steps of: receiving a connection request signal from a PSS through a primary FA (S410); initiating an admission process with the PSS through the primary FA (S420); acquiring service quality information of the PSS from an external policy server (S440); checking a traffic distribution state of the sector to which a connection request by the PSS is made (S450); determining a FA for the PSS based on the service quality information and the traffic distribution state of the sector (S460); transmitting the determined FA information to the PSS (S470); and changing the FA of the PSS to the determined FA (S480).

In the present embodiment, the traffic state of the RAS is recognized in real time and an appropriate FA is assigned to a PSS attempting to enter the wireless network in order to make RAS traffic distribution uniform on the initial state of terminal connection. This requires recognizing loading of each sector within RAS in real time, and controlling overload using the result. The overload control considers the factors, such as the number of current users within the sector, a service type/number for each user, requested QoS for each service, and QoS of service assigned to a new PSS, etc.

The FA assignment module performing the method for assigning a FA of the present embodiment comprises a loading determining unit for loading determining of FA in the sector; and a FA determining unit for determining the FA of the PSS based on the loading of each FA in the sector requested for connection by the PSS. Preferably, the FA assignment module is included in the RAS so that the loading of each FA is easily determined.

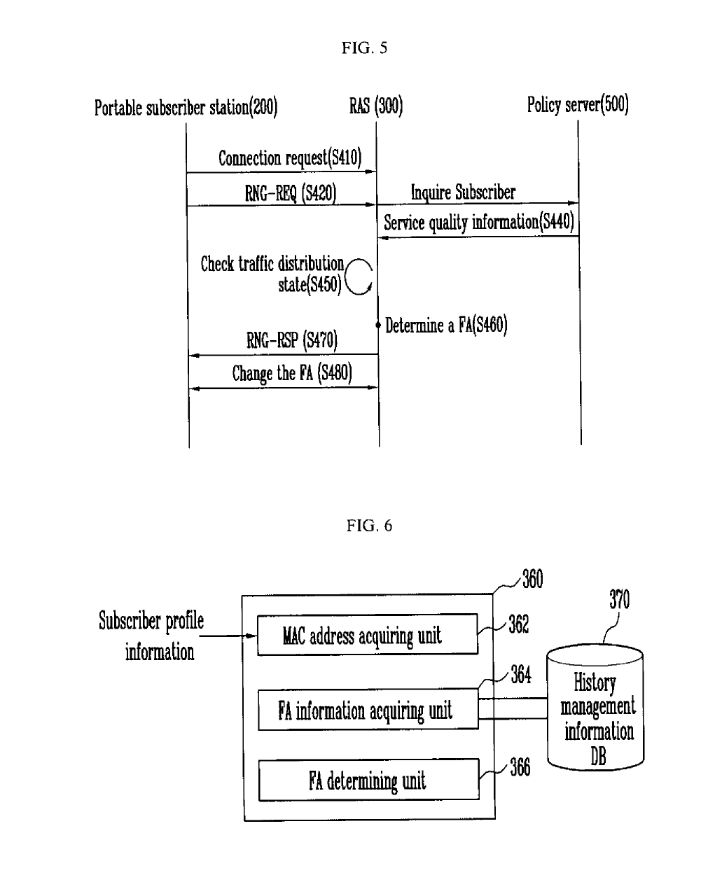

The detailed processes of the method for assigning a FA according to the present embodiment will be described with reference to FIG. 5.

When there is a request for connection by the PSS 200 (S410), the wireless network system and the PSS initiate an admission process (S420), and the subscriber information is transmitted to the policy server via the RAS and the ACR in the admission process. The policy server transmits subscriber's service type information containing quality information corresponding to the subscriber information to the RAS 300 (S440).

Meanwhile, the RAS 300 checks traffic status of the sector that the PSS 200 attempts to access (S450). That is, the RAS 300 recognizes the number of subscribers in a current sector, service type/number of each subscriber, quality for each service (e.g., QoS), and the like.

The RAS 300 then determines a FA for the PSS based on the information on the type of service to be provided to the PSS 200, the quality information, and the information on the available-FA holding status of the sector (S460). The present embodiment is characterized in that the FA is determined based on real-time traffic distribution of the RAS. For example, when a usage rate of FA #1 is 80%, a usage rate of FA#2 is 70%, and a usage rate of FA#3 is 40%, FA#3 having the smallest current loading would be assigned to the terminal in order to distribute traffic.

The traffic status in the RAS may be recognized using the following methods.

In a first method, the traffic status is physically determined. The power of the RAS's antenna is measured to estimate a loading depending on a level of the power. The implementation is easy but the accuracy is somewhat lowered.

In a second method, the loading is determined depending on a record on the operation of a traffic assignment scheduler, which is separately installed in the RAS. The scheduler determines the loading using the type/number of the service occupying a sector within the RAS and the weight dependent on the service type. The traffic assignment scheduler may be an element of an RAS management processor (hereinafter “RMP”) in the RAS.

The RMP includes a number of channel cards that are wireless core modules for each sector/FA, a communication unit for communication with the ACR, a memory for storing information required for call control, and a control unit for generally controlling operation in response to signals input via the communication unit. A RAS state management function, a call connection processing function, a user authentication function, a function of processing handover of a subscriber station, a service billing function, and the like may be implemented in a task form. In the present embodiment, the traffic assignment scheduler may also be implemented in a task form.

The following methods for determining a FA may be implemented depending on a service provider's policy:

A first method is applied when FA assignment at the RAS differs depending on service quality. When the service quality given to the PSS is premium, the RAS determines whether there is premium private FA within the RAS and determines the premium private FA as the FA for the PSS when there is the premium private FA. When normal service is given to the PSS or when there is no premium private FA in the RAS, FA is determined using the following second method.

A second method is applied when service quality differs depending on a type but the FA is not differentiated depending on the quality. In this case, since service of a higher quality occupies a broader FA region, it must be considered in traffic distribution to a number of FAs. For example, the traffic may be calculated by giving a weight to every service quality. For simple example, there is a method of calculating traffic by assigning the weight to each quality of the service. It is assumed that when there are two FAs, FA #1 and FA#2, in which FA #1 includes one normal service channel and four premium service channels and FA #2 includes five normal service channels and one premium service channel, one new normal channel is requested for connection. It can be seen that when a weight of 1.8 is given to the premium service, the FA #1 has traffic of 8.2 (=1+4*1.8) and the FA #2 has traffic of 6.8 (=5+1.8). Since a new normal channel must be assigned to FA #2 for uniform traffic distribution, the FA determining unit determines FA #2 as the FA for the PSS.

The following procedure of changing FA to the determined FA is performed. Upon receipt of a FA determination notification made using a downlink burst profile in the RNG-RSP process (S480), the PSS 200 performs an admission process, a SBC negotiation process and authentication process using a channel card serving the determined FA to complete the initialization, and then is assigned an IP address for executing portable Internet applications. In this case, the admission process may be simply performed using the information obtained by performing FA determination process. For example, an admission context may be formulated while the operating FA is determined, and then only a changed channel card value of the admission context may be modified.

In order to simply maintain the premium private FA when it exists, the premium FA is used for an initial network entry request by the PSS, and the RAS transmits an RES-CMD to request reconnection of the PSS when the service of the RAS is not a premium class as a result of communication with the policy server. In this case, in a ranging process responsive to an entry request re-attempted by the PSS, the FA is changed to the determined FA through a downlink burst profile.

While the invention has been shown and described with reference to certain exemplary embodiments thereof, it will be understood by those skilled in the art that various changes in form and details may be made therein without departing from the spirit and scope of the invention as defined by the appended claims.

1. A method for assigning a frequency assignment (FA) in a wireless network system for wireless portable Internet service, the method comprising the steps of:
(a-1) acquiring a MAC address of a portable subscriber station (PSS) using subscriber information, the subscriber information being provided when the connection request is made by the PSS;
(a-2) acquiring the number of available FAs in a sector where the PSS is located, using history management information of a radio access station (RAS) to which the connection request is requested by the PSS; and
(a-3) determining a FA for the PSS based on the acquired MAC address and the number of available FAs and transmitting the FA information to the PSS.

2. The method of claim 1, wherein the connection request by the PSS is made through a primary FA.

3. The method of claim 1, further comprising the step of, after step (a-3), (a-4) maintaining the FA for the PSS when the determined FA is a primary FA and changing the FA for the PSS from the primary FA to the determined FA when the determined FA is not the primary FA.

4. The method of claim 1, wherein step (a-3) comprises determining a FA having a serial number corresponding to a remainder of division of the MAC address by the number of the available FAs as the FA for the PSS.

5. The method of claim 1, wherein step (a-3) comprises determining the FA for the PSS using an algorithm which is based on at least one of a range of MAC addresses assigned to wireless portable Internet, a range of MAC addresses that are more likely to be used geographically, a range of MAC addresses that can be assigned depending on a wireless communication service type, and a range of MAC addresses that can be assigned depending on service providers.

6. The method of claim 1, wherein step (a-1) comprises retrieving the MAC address from subscriber information in an RNG-REQ signal received from the PSS in a ranging process.

7. The method of claim 1, wherein step (a-2) comprises retrieving the number of available FAs from a history management information database (DB) for the RAS.

8. The method of claim 1, wherein step (a-3) comprises transmitting an RNG-RSP signal including information on the determined FA to the PSS in a ranging process.

9. The method of claim 3, further comprising the step of, after step (a-4),
(a-5) initializing a connection to the PSS by performing an admission process, an SBC negotiation process, and an authentication process through the determined FA.

10. The method of claim 9, wherein, in step (a-5), the admission process formulates an admission context including access information of the PSS connection and modifies only a changed channel card value in the formulated admission context according to the determined FA.

11. The method of claim 1, wherein the method is performed by a RAS of a wireless portable Internet service system conforming to the IEEE 802.16e or IEEE 802.16d standard.

12. The method of claim 1, wherein the method is performed by an ACR of a wireless portable Internet service system conforming to IEEE 802.16e or IEEE 802.16d standard.

13. A method for assigning a FA in a wireless portable Internet service system comprising a PSS of a subscriber, a wireless network system for providing a wireless network available to the PSS, and a policy server having information on the subscriber, the method comprising the steps of:
(b-1) acquiring an identification value of the PSS using subscriber information, the subscriber information being provided when a connection request is made by the PSS;
(b-2) receiving FA information using the identification value of the PSS, the FA information being predetermined based on a subscriber service type by the policy server; and
(b-3) transmitting the received FA information to the PSS.

14. The method of claim 13, further comprising the step of, after step (b-3),
(b-4) maintaining the FA for the PSS in the case that the determined FA is a primary FA and changing the FA for the PSS from the primary FA to the determined FA in the case that the determined FA is not the primary FA.

15. The method of claim 14, further comprising the step of, after step (b-3), (b-5) initializing a connection to the PSS by performing an admission process, an SBC negotiation process, and an authentication process through the received FA.

16. The method of claim 15, wherein, in step (b-5), the admission process formulates an admission context containing connection information of the PSS and modifies only a changed channel card value in the formulated admission context according to the determined FA.

17. The method of claim 13, wherein the policy server comprises a subscriber service DB that stores a service type for the subscriber, service quality information, and corresponding predefined FA information.

18. A method for assigning a FA in a wireless network system for wireless portable Internet service, the method comprising the steps of:
(c-1) receiving a connection request signal from a PSS through a primary FA;
(c-2) initiating a process of initializing a connection with the PSS through the primary FA;
(c-3) checking a traffic distribution state of a sector to which a connection request is made by the PSS; and
(c-4) determining a FA for the PSS based on the traffic distribution state of the sector and transmitting the determined FA information to the PSS.

19. The method of claim 18, wherein step (c-4) comprises determining loading based on a power level of an antenna of the RAS to which a connection request is made by the PSS and determining a FA having the smallest loading as the FA for the PSS.

20. The method of claim 18, wherein step (c-4) comprises determining loading using a weight dependent on a service type for the subscriber and determining a FA having the smallest loading as the FA for the PSS.

21. The method of claim 18, further comprising the step of, after step (c-4),
(c-5) maintaining the FA for the PSS when the determined FA is a primary FA and changing the FA for the PSS from the primary FA to the determined FA when the determined FA is not a primary FA.

22. The method of claim 18, further comprising the step of, after step (c-4),
(c-5) initializing a connection to the PSS by performing an admission process, an SBC negotiation process, and an authentication process through the determined FA.

23. The method of claim 18 wherein the method is performed by an RMP in a RAS of a wireless portable Internet service system conforming to the IEEE 802.16e or IEEE 802.16d standard.

24. A FA assignment module comprising:
a MAC address acquiring unit for acquiring a MAC address of a PSS by retrieving subscriber information received from the PSS when the PSS is initialized for a connection;
a FA information acquiring unit for acquiring information on the number of available FAs of a sector to which a connection request is made; and
a FA determining unit for determining a FA for the PSS based on the acquired MAC

25. The module of claim 24, wherein the MAC address acquiring unit acquires a MAC address by retrieving an RNG-REQ signal received from the PSS.

26. The module of claim 24, wherein the FA information acquiring unit retrieves the number of available FAs from a history management information DB for the RAS.

27. The module of claim 24, wherein the FA determining unit determines a FA having a serial number corresponding to a remainder of division of the MAC address by the number of the available FAs as the FA for the PSS.

28. The module of claim 24, wherein the FA determining unit uses an algorithm considering at least one of a range of MAC addresses assigned to wireless portable Internet, a range of MAC addresses that are more likely to be used geographically, a range of MAC addresses that can be assigned depending on a wireless communication service type, and a range of MAC addresses that can be assigned depending on service providers.

29. The module of claim 24, wherein the FA determining unit receives FA information predetermined on a basis of a subscriber service type from the policy server using the MAC address to determine the FA for the PSS.

30. A FA assignment module comprising:
a loading determining unit for determining loading of each of FAs in a RAS; and
a FA determining unit for determining the FA of the PSS based on the loading of each FA of a sector to which a connection request is made by the PSS.

31. The module of claim 30, wherein the loading determining unit determines the loading based on a power level of an antenna of a RAS to which a connection request is made by the PSS, and the FA determining unit determines a FA having the smallest loading as the FA for the PSS.

32. The module of claim 30, wherein the loading determining unit determines the loading based on a weight dependent on a service type for the subscriber, and the FA determining unit determines a FA having the smallest loading as the FA for the PSS.

33. The module of claim 24, wherein the FA assignment module is a RAS component of a wireless Internet service system conforming to the IEEE 802.16e or IEEE 802.16d standard.

34. The module of claim 24, wherein the FA assignment module is an ACR component of a wireless Internet service system conforming to the IEEE 802.16e or IEEE 802.16d standard.
